(19) United States
(12) Patent Application Publication
(10) Pub. No.: US 2019/0351642 A1
(43) Pub. Date: Nov. 21, 2019

(54) SELF-SUPPORTING LATTICE STRUCTURE

(71) Applicant: DIVERGENT TECHNOLOGIES, INC., Los Angeles, CA (US)

(72) Inventor: Muhammad Faizan Zafar, Long Beach, CA (US)

(21) Appl. No.: 15/980,247

(22) Filed: May 15, 2018

(51) Int. Cl. B32B 3/26; B29C 64/118; B32B 27/08; B33Y 10/00; B33Y 80/00

(52) U.S. Cl. CPC B32B 3/26; B29C 64/118; B29K 2101/12; B33Y 10/00; B33Y 80/00; B32B 27/08

(57) ABSTRACT

A self-supporting lattice structure is provided with high strength-to-weight ratios. In an aspect, an additively manufactured structure is provided that includes a self-supporting lattice structure formed by a plurality of unit cells. Moreover, each unit cell includes a symmetrical frame with voids or cutouts extending through each of the side surfaces of the symmetrical frame to define a negative space therein. The negative space substantially reduces the density and overall weight of the self-supporting lattice structure.

### BACKGROUND

### Technical Field

The present disclosure relates generally to cellular structures used in structural applications, and, more particularly, to a self-supporting lattice structure having high strength-to-weight ratios.

### Background

In general, a lattice structure is a cellular structure that provides high strength-to-weight ratios for performance. Lattice structures have a plurality of unit cells that are geometrically propagated sequentially in a volume. Depending on the design of the unit cell, the lattice structure will have differing properties in different directions. Accordingly, lattices can be very useful engineering tools since they can be used to provide stiffness and strength to structures at a very low mass penalty.

In application, lattice structures can be utilized as core materials for different manufactured components for any industry. For example, in certain applications, lattices can be used as core materials in transport structures, for example, where such components can be provided for use in vehicles, trucks, trains, motorcycles, boats, aircraft, and the like. Generally, the types of components used in these structures will be formed of a rigid structural member composed of metal, an alloy, a polymer, or another suitable material. The structural member will have a predefined shape and include one or more surfaces and cavities. For example, part of an interior door panel in a vehicle may include a metal or plastic structure with an internal lattice structure formed therein that can be designed for the loads to which it will be subject when it is assembled as a component of the automobile. Some of the existing lattice structure geometries used as core materials for such manufactured components include tetrahedral, pyramidal, and octet truss, kagome, honeycomb and the like. Moreover, the size of the cells can be varied from one lattice to another, but typically in a given lattice, the cells are all of one size.

Although lattice structures can be effectively used as core materials for certain manufactured components, there are many technical and design limitations that prevent lattice structures from being used on a wide scale for manufacturing such structural components. One critical limitation for such use is due to the orientation dependency for 3-D printing of lattice structures. In general, design of engineering components must take into consideration several orientation dependencies due to the required features. Typically, engineering features hold preference for printing orientation compared to the internal design of the structure. Therefore, existing lattices are designed based on the understood print vector of the component to be manufactured. Thus, as the print vector evolves throughout the design process, lattice orientations will evolve with it. However, due to the high computational strain of lattice structures on computer-aided design (“CAD”) and finite element (“FE”) analysis software, it is not possible to continuously evolve the lattice structure based on the continuous evolution of the print vectors. Accordingly, there is a need for a lattice structure that is not orientation dependent for printing.

### SUMMARY

Printing orientation of a lattice structure is dictated by the printing orientation of the unit cell of the lattice from where the propagation of the cells begins. Therefore, it is important to design a unit cell that is orientation proof. This means that the unit cell not only needs to be designed such that it is printable without supports in any direction, but also should have reflective as well as rotational symmetry about all axes.

Thus, according to an exemplary aspect, an additively manufactured structure is provided that includes a self-supporting lattice structure including a plurality of unit cells. Moreover, in this aspect, each of the plurality of unit cells has a symmetrical frame with a plurality of voids extending through each of a plurality of side surfaces of the symmetrical frame to define a negative space therein. In one aspect, the plurality of voids are formed by cylindrical cutouts that intersect at a center of the cubic block to define the negative space therein. Moreover, in one aspect, each of the plurality of unit cells is completely symmetrical reflectively and rotationally about each of an X axis, Y axis, and Z axis of the cubic block.

According to another exemplary aspect, an additively manufactured structure is provided that includes a plurality of unit cells forming a self-supporting lattice structure. In this aspect, each of the plurality of unit cells comprises a symmetrical cubic block with a plurality of cylindrical cutouts extending through each side surface of the cubic block to define a negative space therein.

In yet another exemplary aspect, a method for additively manufacturing an object is provided. In this aspect, the method includes forming a self-supporting lattice structure that includes a plurality of unit cells with symmetrical frames. Moreover, the method further includes forming a plurality of voids that extend through each of a plurality of side surfaces of the symmetrical frame of each of the unit cell to define a negative space therein.

It should be understood that other aspects of the exemplary systems and methods for manufacturing composite structures will become readily apparent to those skilled in the art from the following detailed description, wherein it is shown and described only several embodiments by way of illustration. As will be realized by those skilled in the art, the parts and methods of producing the parts are capable of other and different embodiments and its several details are capable of modification in various other respects, all without departing from the invention. Accordingly, the drawings and detailed description are to be regarded as illustrative in nature and not as restrictive.

### BRIEF DESCRIPTION OF THE DRAWINGS

A self-supporting lattice structure and method for manufacturing the same will now be presented in the detailed description by way of example, and not by way of limitation, in the accompanying drawings, wherein:

FIG. 1 provides a flow diagram illustrating an exemplary process of initiating a process of 3-D printing.

FIG. 2 illustrates a block diagram of a 3-D printer configured to provide a self-supporting lattice structure according to an exemplary aspect.

FIG. 3 schematically illustrates a unit cell of the self-supporting lattice structure according to an exemplary aspect.

FIG. 4 schematically illustrates a self-supporting lattice structure according to an exemplary aspect.

FIG. 5 illustrates exemplary perspective views of lattice structures according to an exemplary aspect.

FIG. 6A schematically illustrates a unit cell of a self-supporting lattice structure according to another exemplary aspect. FIG. 6B schematically illustrates a cross-sectional view a self-supporting lattice structure incorporating the unit cells shown in FIG. 6A.

FIG. 7A schematically illustrates a unit cell of a self-supporting lattice structure having a cylindrical void or cutout according to an exemplary aspect. FIG. 7B schematically illustrates a cross-sectional view of a self-supporting lattice structure incorporating a plurality of cylindrical voids as shown in FIG. 7A.

FIG. 8A schematically illustrates a cross-sectional view of a self-supporting lattice structure incorporating a plurality of the unit cells according to another exemplary aspect. FIG. 8B illustrates a larger cross-sectional view of the supporting lattice structure shown in FIG. 8A. FIG. 8C illustrates a three-dimensional perspective view of the exemplary supporting lattice structure shown in FIG. 8A.

### DETAILED DESCRIPTION

The detailed description set forth below in connection with the appended drawings is intended to provide a description of various exemplary embodiments of a self-supporting lattice structure and method of manufacturing the same according to exemplary aspects disclosed herein and is not intended to represent the only embodiments in which the invention may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout this disclosure.

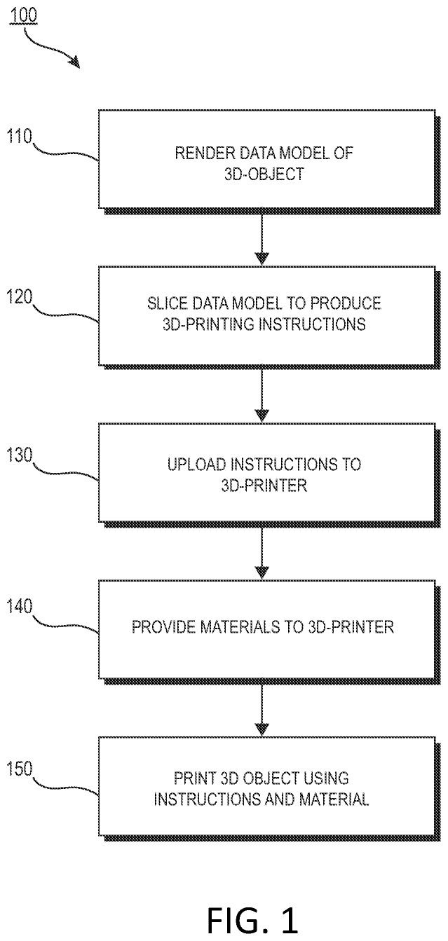

FIG. 1 provides a flow diagram 100 illustrating an exemplary process of initiating a process of 3-D printing, which can be used for forming the self-supporting lattice structure according to an exemplary aspect. Initially, at step 110, a data model is generated of the desired 3-D object (e.g., the lattice and/or shell including the lattice as a core material) to be printed is rendered. A data model is a virtual design of the 3-D object to be manufactured. Thus, the data model may reflect the geometrical and structural features of the 3-D object, as well as its material composition, including load (i.e., strength) requirements of the core material for the manufactured structure. The data model may be created using a variety of methods, including 3-D scanning, 3-D modeling software, photogrammetry software, and camera imaging. In general, 3-D scanning methods for creating the data model may also use a variety of techniques for generating a 3-D model. These techniques may include, for example, time-of flight, volumetric scanning, structured light, modulated light, laser scanning, triangulation, and the like.

3-D modeling software, in turn, may include one of numerous commercially available 3-D modeling software applications. Data models may be rendered using a suitable CAD package, for example in an STL format. STL files are one example of a file format associated with commercially available CAD software. A CAD program may be used to create the data model of the 3-D object as an STL file. Thereupon, the STL file may undergo a process whereby errors in the file are identified and resolved.

Following error resolution, the data model can be “sliced” at step 120 by a software application known as a slicer to thereby produce a set of instructions for 3-D printing the object, with the instructions being compatible and associated with the particular 3-D printing technology to be utilized. Numerous slicer programs are commercially available. Slicer programs convert the data model into a series of individual layers representing thin slices (e.g., 100 microns thick) of the object be printed, along with a file containing the printer-specific instructions for 3-D printing these successive individual layers to produce an actual 3-D printed representation of the data model.

In an exemplary aspect, a common type of file used for this purpose is a G-code file, which is a numerical control programming language that includes instructions for 3-D printing the object. The G-code file, or other file constituting the instructions, is uploaded to the 3-D printer at step 130. Because the file containing these instructions is typically configured to be operable with a specific 3-D printing process, it will be appreciated that many formats of the instruction file are possible depending on the 3-D printing technology used.

In addition to the printing instructions that dictate what and how an object is to be rendered, the appropriate physical materials necessary for use by the 3-D printer in rendering the object are loaded into the 3-D printer using any of several conventional and often printer-specific methods at step 140. For example, in fused deposition modelling (FDM) 3-D printers, for example, materials are often loaded as filaments on spools, which are placed on one or more spool holders. The filaments are typically fed into an extruder apparatus which, in operation, heats the filament into a melted form before ejecting the material onto a build plate or other substrate, as further explained below. In selective laser sintering (SLS) printing and other methods, the materials may be loaded as powders into chambers that feed the powder to a build platform. Depending on the 3-D printer, other techniques for loading printing materials may be used.

Finally, at step 150, the respective data slices of the 3-D object are then printed based on the provided instructions using the material(s). In 3-D printers that use laser sintering, a laser scans a powder bed and melts the powder together where structure is desired, and avoids scanning areas where the sliced data indicates that nothing is to be printed. This process may be repeated thousands of times until the desired structure is formed, after which the printed part is removed from a fabricator. In fused deposition modelling, parts are printed by applying successive layers of model and support materials to a substrate. In general, any suitable 3-D printing technology may be employed for purposes of manufacturing a self-supporting lattice structure that includes a plurality of symmetrical unit cells as described herein.

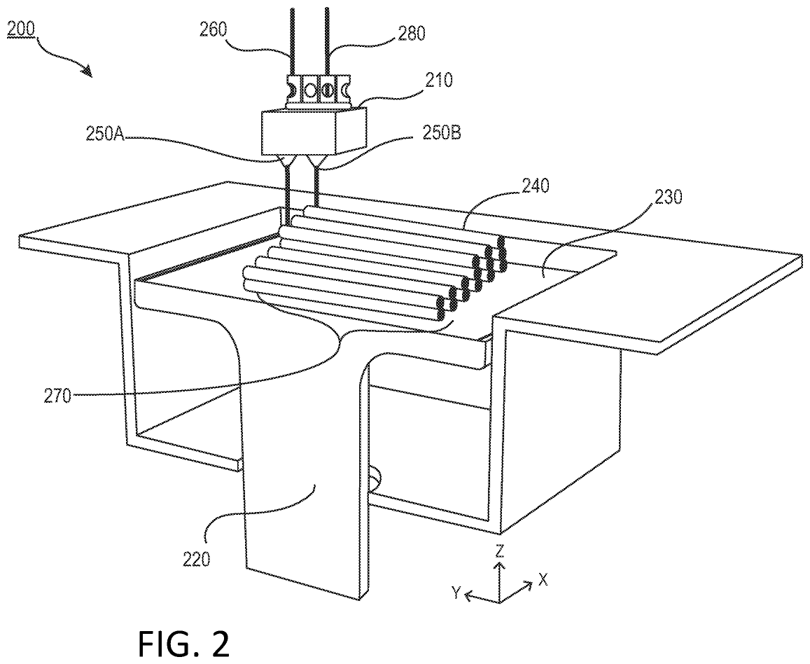

FIG. 2 illustrates a block diagram of a 3-D printer 200 configured to print a self-supporting lattice structure according to an exemplary aspect. While any number of 3-D printing technologies can be suitably employed as noted above, the 3-D printer 200 of FIG. 2 is discussed in the context of an FDM technique. 3-D printer 200 includes an FDM head 210 which in turn includes extrusion nozzles 250A and 250B, a moveable build stage 220, and a build plate 230 at the top of the build stage 220. In one exemplary aspect, the 3-D printer is configured to form a shell for the structure with one or a plurality of pockets for providing the self-supporting lattice structure therein as the core material for additional reinforcement where needed.

It is noted that while the exemplary self-supporting lattice structures are described as being manufactured using an FDM technique as described herein, the self-supporting lattice structure can be manufactured using various different manufacturing processes that are known to those skilled in the art. For example, the printing process selected for the manufacturing of the self-supporting lattice structure can depend on a variety of factors known to those skilled in the art, including, for example, material of the lattice, Coefficient of Thermal Expansion (“CTE”) of the lattice, and compatibility with the CTE of the structure shell during the curing process, melting/glass transition temperature of the self-supporting lattice structure and the like. For example, in another exemplary aspect, the self-supporting lattice structure can be manufactured using a power-bed fusion (“PBF”) system.

In general, depending on the intended composition of the self-supporting lattice structure, a plurality of materials may be used for printing the lattice. For example, one or more suitable filament materials 260 may be wound on a spool (not shown) and fed into FDM head 210. In other technologies described above, the material may be provided as a powder or in other forms, for example. The FDM head 210 can be moved in X-Y directions based on the received printing instructions by a numerically controlled mechanism such as a stepper motor or servo motor. The material, which may in one exemplary embodiment constitute a thermoplastic polymer, may be fed to the FDM head 210 which includes the extrusion nozzles 250A and 250B. The extruder in FDM head 210 heats the filament material 260 into a molten form, and extrusion nozzle 250a ejects the molten material and deposits it onto the build plate 230 of build stage 220.

Responsive to the received printing instructions, the FDM head 210 moves about a horizontal (X-Y) plane such that extrusion nozzle 250A drops the material 260 at the target location to form a line 240 of applied material. In an exemplary aspect, the FDM head 210 may also be configured to move in the Z-direction and/or to rotate about one or more axes in certain configurations. The layer 270 of material 260, including line 240, is formed by depositing the material 260 line by line, with each line of the material 260 hardening as the material is deposited on the build plate 230. After one layer 270 is formed at the appropriate locations in the X-Y plane, the next layer may be formed in a similar way.

When rendering of a layer 270 for the lattice structure is completed, the build stage 220 and build plate 230 may lower by an amount proportional to the thickness of layer 270 in the vertical (Z) direction so that the printer can begin application of the next layer, and so on until a plurality of cross sectional layers 240 having a desired shape and composition are created.

While a substantially rectangular structure of layers 240 is shown for printing the lattice for purposes of simplicity in this illustration, it will be appreciated that the actual printed structure may embody substantially any shape and configuration depending on the data model, which specifies the shape of the core material required to be disposed in the structure to be manufactured. In addition, as indicated above, a plurality of different materials may be used to print the lattice in an exemplary aspect. In some instances, two different materials 260 and 280 may concurrently be applied by respective extruder nozzles 250A and 250B.

In general, the lattice structures described herein are self-supporting in that they do not require any support for the unit cells and the printing of the lattice structures is not orientation dependent in the manufacturing process. More particularly, the inventors have determined that typical printed lattices comprised of unit-cells that are made from 2-D members require support. In other words, in conventional lattice structures, lattice elements need to be supported during the 3D printing process, if they are overhanging structures, for example, by extra supports generated during the print. However, these extra supports do not serve any functional purpose apart from simply supporting the elements during the print, and, therefore, must be removed/broken off upon completion of the print of the lattice structure. In some instances, additive manufacturing techniques have printed cylindrical sections upwards of 15 mm, for example, in diameter without the need for support. However, the printing of such structures are still orientation dependent in the manufacturing process. The self-supporting lattice structure disclosed herein addresses these technical limitations of existing lattice structures by utilizing existing lattice elements that serve as support for the other lattice elements to effectively provide a self-supporting structure where such lattice elements do not need to be removed after completion of the 3D print.

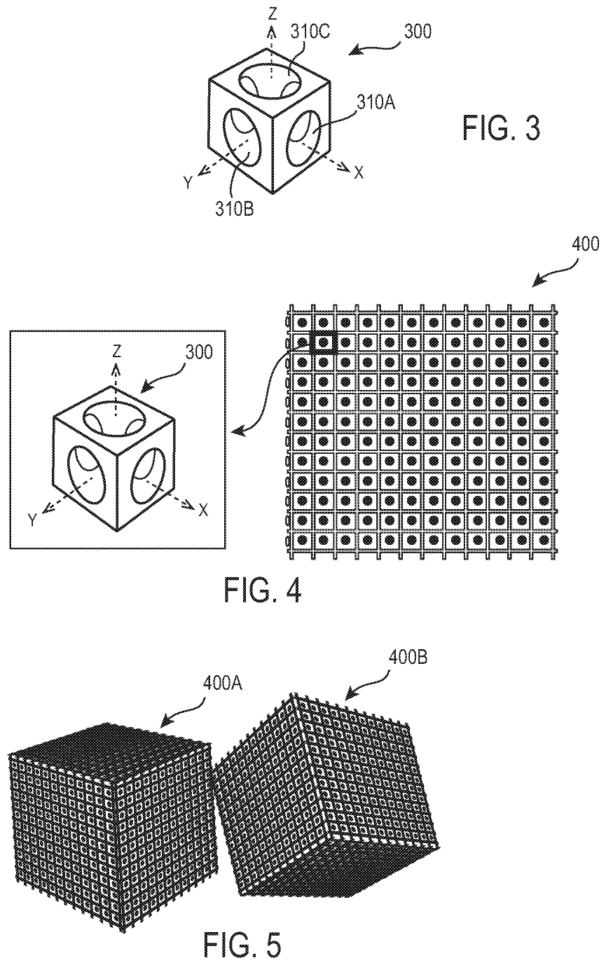

FIG. 3 schematically illustrates a unit cell of the self-supporting lattice structure according to an exemplary aspect. In particular, as shown, the unit cell 300 is a completely symmetrical square (i.e., a symmetrical frame) that incorporates the negative space of the unit cell 300, which is shown as cylindrical cutouts extending therethrough in the X, Y and Z axes of the unit cell 300.

According to the exemplary aspect, the unit cell 300 is a cubic block that includes six equally dimensioned side surfaces (i.e., square side surfaces) with a plurality of voids extending therethrough, respectively. For example, in an exemplary aspect, a separate cylindrical column can extend through each the first, second and third pairs of opposing surfaces of the cubic block. Thus, as shown, a first columnar cutout 310A extends in the X-axis direction, a second columnar cutout 310B extends in the Y-axis direction, and third columnar cutout 310C extends in the Z-axis direction. As a result, each of the three columnar cutouts 310A-310C will intersect with one another at the center point of the unit cell 300 and collective define negative space of the unit cell 300. Advantageously, the exemplary unit cell 300 that forms the resulting lattice structure can be revolved about any axes and maintain a geometry that is symmetrical. In other words, the exemplary unit cell 300 is completely symmetrical reflectively and rotationally about all axes.

FIG. 4 schematically illustrates a self-supporting lattice structure according to an exemplary aspect. As shown, the self-supporting lattice structure 400 includes a plurality of unit cells 300, with each of the unit cells being stacked on one another and each being completely symmetrical reflectively and rotationally about all axes. It is noted that the self-supporting lattice structure 400 is only shown in a two dimensional view (in the X and Y axis), but will of course be a three dimensional structure in application. Moreover, while the lattice structure 400 is also shown as a cubic or square structure, it should be understood that the lattice structure 400 can have any shape as required, for example, to form the core material of a three-dimensional object to be manufactured. Moreover, because each unit cell 300 is completely symmetrical reflectively and rotationally, the printing of the lattice structure 400 is not orientation dependent, which enables the print vector of the component to be manufactured to be easily adjusted during the design process without needing to take into account any specific printing orientation for the lattice structure itself

As noted above, since the unit cells of the exemplary lattice structure are completely symmetrical reflectively and rotationally, the lattice structure can be printed without any supports. FIG. 5 illustrates exemplary perspective views of lattice structures according to an exemplary aspect. In general, lattice structures 400A and 400B are shown to be printed in various orientation and can be printed without supports during the printing process. Moreover, by printing the unit cells with negative space, the resulting lattice structure according to the exemplary aspect provides an improved strength-to-weight ratio compared with existing lattice structures currently being used as core materials in structural application.

It should be appreciated that while the exemplary self-supporting lattice structure disclosed herein is described with respective to a plurality of cylindrical voids extending therethrough in all three axes of direction according to the exemplary aspect, alternative embodiments of the lattice structure are contemplated that utilize negative space according to variations of the exemplary aspects. For example, in another exemplary aspect, a self-supporting lattice structure is provided in which the exemplary idea is applied to negative spaces that have spherical cutouts or voids.

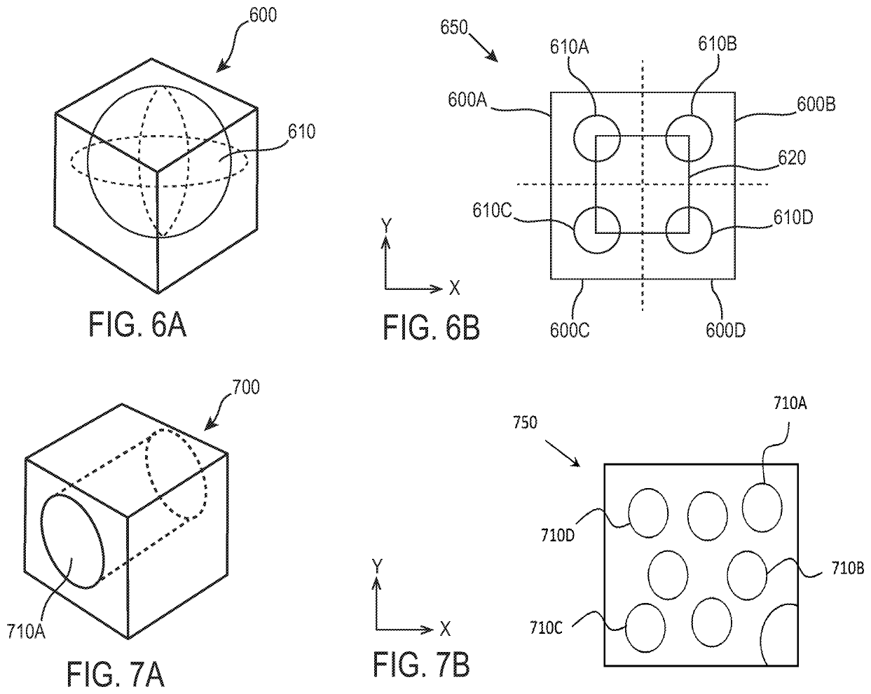

FIG. 6A schematically illustrates a unit cell of a self-supporting lattice structure according to another exemplary aspect. As shown, the unit cell 600 includes a spherical cutout 610 (or void) disposed therein that defines a negative space of the unit cell 600. The spherical cutout 610 reduces the weight of the overall lattice structure while also maintaining the completely symmetrical configuration of the unit cell 600, which in turn provides the manufacturing advantages discussed above. It should also be appreciated that the unit cell 600 can be manufactured using any of the 3-D printing processes described above. Advantageously, since a sphere is inherently symmetrical in all directions, adding the spherical cutout 610 to the lattice will create a void that can still be 3D printed. Thus, if such a spherical cutout 610 is made an integral part of the unit cell 600, then a resulting lattice can be manufactured that is even lighter than conventional designs, thus further improving the strength-to-weight ratio of the lattice.

FIG. 6B schematically illustrates a cross-sectional view a self-supporting lattice structure 650 incorporating the unit cell 610. More particularly, the cross-sectional view is shown in the X and Y axes and illustrates four unit cells formed in a stacked orientation adjacent to one another. Each of the spherical voids or cutouts 610A-610D are shown as negative spaces 610A-610D of the four unit cells. Moreover, reference 620 is shown as an imaginary line that connects the center point of each of the negative spaces 610A-610D. As can readily be seen by the cross-sectional view, the self-support lattice structure 650 can be formed with a plurality of completely symmetrical unit cells 610, such that the resulting lattice can be manufactured with any overall shape (to be provided as a core material, for example) without the need to set a printing direction that is orientation dependent.

Thus, according to the exemplary embodiments described above, self-supporting lattice structures can be printed with both cylindrical negative spaces and spherical negative spaces in each of the unit cells without support. Thus, it should be appreciated that variations of these designs can be implemented with combinations of cylindrical and spherical negative spaces, which advantageously provides a lattice structure with increased strength-to-weight ratio and decreased density of the overall lattice structure.

FIG. 7A schematically illustrates a unit cell of a self-supporting lattice structure having a cylindrical void or cutout as described above according to an exemplary aspect. As shown, the unit cell 700 includes a cylindrical cutout 710 disposed therein that defines a negative space of the unit cell 700. The cylindrical cutout 710 extends between two opposing side surfaces of the unit cell 700 in this aspect. Moreover, it is noted that the unit cell 700 can be manufactured using any of the 3-D printing processes described above to provide the cylindrical negative space.

In addition, FIG. 7B schematically illustrates how a plurality of cylindrical voids 710A to 710D, for example, may be incorporated in a self-supporting lattice structure 750, according to another exemplary aspect. More particularly, the cross-sectional view is shown in the X and Y axes and illustrates a plurality of unit cells adjacent to one another with a plurality of negative spaces (e.g., cylindrical voids 710A to 710D) formed therein.

The exemplary unit cells 600 and 700 described above can be 3D printed with respective cylindrical negative spaces and spherical negative spaces in each unit cell of the respective lattice structure and can be done so without support. In addition, it should be appreciated that variations in the exemplary lattice structures can be provided that include combinations of cylindrical and spherical negative spaces.

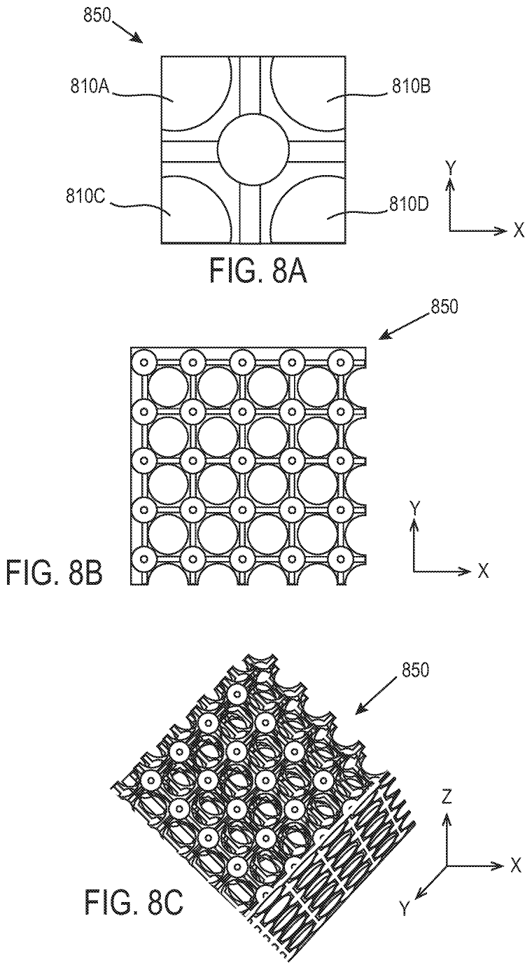

For example, FIG. 8A schematically illustrates a cross-sectional view of a self-supporting lattice structure 850 incorporating a plurality of the unit cells according to another exemplary aspect. In this aspect, each unit cell includes a void that define both one or more cylindrical negative spaces extending therethrough and a spherical negative space therein. For example, the cross-sectional view illustrates a partial view of four adjacent unit cells each having a cylindrical negative space 810A to 810D, respectively, extending therethrough.

Moreover, FIG. 8B illustrates a larger cross-sectional view of the supporting lattice structure 850 according this exemplary aspect. As shown, a two-dimensional view is shown in the X and Y axes directions and includes a 4×4 lattice structure (i.e., 4 by 4 unit cells) in which each unit cell includes a cylindrical cutout or void extending therethrough. In addition, FIG. 8C illustrates a three-dimensional perspective view of the exemplary supporting lattice structure 850 according this exemplary aspect. As noted above, each unit cell includes one or more cylindrical cutouts extending therethrough and also includes a spherical cutout therein that further defines negative space in order to reduce the overall weight and density of the exemplary self-supporting lattice structure 850. In addition, the combination of spherical and cylindrical cutouts provides a further technical advantage to facilitate powder removal upon completion of the print when a powder-based system is used for the 3D printing of the lattice structure. For example, if only spherical cutouts are used for the lattice structure when printed with a powder-based system, the powder may be trapped in the spherical cutouts. Thus, by also provided cylindrical cutouts, the cylindrical cutouts can also function as powder removal channels through which the trapped powder may egress from the unit cell.

Thus, according to the exemplary embodiments described above, a self-supporting lattice structure can be 3D printed (i.e., additively manufactured) to include negative space therein. As described above, self-supporting lattice structures provide the technical advantage of increasing strength-to-weight ratios compared with existing designs. Moreover, each unit cell of the self-supporting lattice structure is preferably printed to be completely symmetrical about all axes (i.e., the X, Y, and Z axes). Such symmetrical designs enable the lattice structure to be 3D printed without any print vector orientation requirement, and, therefore, without needing any support in any directions. As a result, when the print vector of the underlying component is changed, the lattice orientation (provided as a core material, for example) does not need to be adjusted since it is not print direction dependent. This substantially reduces the computational strain on CAD and FE analysis software for designing and printing the manufactured structured, and, therefore, substantially increases the possible applications and uses of the exemplary lattice structure as part of a manufactured component, for example.

It is noted that in the interest of clarity, not all of the routine features of the exemplary aspects are disclosed herein. It will be appreciated that in the development of any actual implementation of the present disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other techniques for composite inlay of materials. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed:

1. An additively manufactured structure comprising:
a self-supporting lattice structure including a plurality of unit cells,
wherein each of the plurality of unit cells comprises a symmetrical frame with a plurality of voids extending through each of a plurality of side surfaces of the symmetrical frame to define a negative space therein.

2. The additively manufactured structure according to claim 1, wherein each of the plurality of unit cells comprises a cubic block with first, second and third pairs of opposing side surfaces.

3. The additively manufactured structure according to claim 2, wherein the plurality of voids comprises cylindrical cutouts to define the negative space.

4. The additively manufactured structure according to claim 3, wherein the cylindrical cutouts comprise a first cylindrical cutout extending through the first pair of opposing surfaces, a second cylindrical cutout extending through the second pair of opposing surfaces, and a third cylindrical cutout extending through the third pair of opposing surfaces.

5. The additively manufactured structure according to claim 4, wherein the first, second and third cylindrical cutouts intersect at a center of the cubic block to define the negative space therein.

6. The additively manufactured structure according to claim 3, wherein each of the plurality of unit cells comprises a spherical cutout therein, such that the spherical cutout and the cylindrical cutouts collectively define the negative space.

7. The additively manufactured structure according to claim 2, wherein each of the plurality of unit cells is completely symmetrical reflectively and rotationally about each of an X axis, Y axis, and Z axis of the cubic block.

8. An additively manufactured structure comprising:
a plurality of unit cells forming a self-supporting lattice structure,
wherein each of the plurality of unit cells comprises a symmetrical cubic block with a plurality of cylindrical cutouts extending through each side surface of the cubic block to define a negative space therein.

9. The additively manufactured structure according to claim 8, wherein each of the plurality of unit cells comprises first, second and third pairs of opposing side surfaces.

10. The additively manufactured structure according to claim 9, wherein the cylindrical cutouts comprise a first cylindrical cutout extending through the first pair of opposing surfaces, a second cylindrical cutout extending through the second pair of opposing surfaces, and a third cylindrical cutout extending through the third pair of opposing surfaces.

11. The additively manufactured structure according to claim 10, wherein the first, second and third cylindrical cutouts intersect in the cubic block to define the negative space therein.

12. The additively manufactured structure according to claim 8, wherein each of the plurality of unit cells comprises a spherical cutout therein, such that the spherical cutout and the plurality of cylindrical cutouts collectively define the negative space.

13. The additively manufactured structure according to claim 8, wherein each of the plurality of unit cells is completely symmetrical reflectively and rotationally about each of an X axis, Y axis, and Z axis of the cubic block.

14. A method for additively manufacturing an object, the method comprising:
forming a self-supporting lattice structure that includes a plurality of unit cells with symmetrical frames; and
forming a plurality of voids that extend through each of a plurality of side surfaces of the symmetrical frame of each of the unit cell to define a negative space therein.

15. The method for additively manufacturing according to claim 14, wherein the forming of the self-supporting lattice structure comprises three-dimensional (3D) printing the self-supporting lattice structure.

16. The method for additively manufacturing according to claim 15, further comprising forming each of the plurality of unit cells by the 3D printing as a plurality of cubic blocks that each include first, second and third pairs of opposing side surfaces.

17. The method for additively manufacturing according to claim 16, further comprising forming the plurality of voids as cylindrical cutouts to define the negative space.

18. The method for additively manufacturing according to claim 17, further comprising forming a first cylindrical cutout extending through the first pair of opposing surfaces, a second cylindrical cutout extending through the second pair of opposing surfaces, and a third cylindrical cutout extending through the third pair of opposing surfaces.

19. The method for additively manufacturing according to claim 18, further comprising forming the first, second and third cylindrical cutouts to intersect at a center of the cubic block to define the negative space therein.

20. The method for additively manufacturing according to claim 17, further comprising forming a spherical cutout in each of the plurality of unit cells, such that the spherical cutout and the cylindrical cutouts collectively define the negative space.

21. The method for additively manufacturing according to claim 16, further comprising forming each of the plurality of unit cells to be completely symmetrical reflectively and rotationally about each of an X axis, Y axis, and Z axis of the cubic block.
